(19) United States
(12) Patent Application Publication
(10) Pub. No.: US 2005/0182692 A1
(43) Pub. Date: Aug. 18, 2005

(54) Product finder system and method

(76) Inventor: Michael T. Woos, Bay Village, OH (US)

Correspondence Address: WOODCOCK WASHBURN LLP, ONE LIBERTY PLACE, 46TH FLOOR, PHILADELPHIA, PA, 19103, US

(21) Appl. No.: 11/038,976

(22) Filed: Jan. 18, 2005

Related U.S. Application Data
(60) Provisional application No. 60/538,991, filed on Jan. 23, 2004.

(51) Int. Cl. G06F 17/60

(52) U.S. Cl. 705/27; 705/26

(57) ABSTRACT

A method and system for enabling a consumer to select and identify a product having a desired characteristic is disclosed herein. In the method, a product selection guide having a choice corresponding to the desired characteristic, and an icon selector corresponding to a plurality of product characteristics, is presented. Modification of the icon selector is enabled, where the modification reflects a consumer choice selection.

### CROSS REFERENCE TO RELATED APPLICATION

This application claims priority under 35 U.S.C. § 119(e) from the following U.S. provisional application filed on Jan. 23, 2004: Ser. No. 60/538,991 (Attorney Docket No. HENK-0049), entitled “Product Finder System and Method.” The above-listed U.S. provisional application is incorporated by reference herein, in its entirety, for all purposes.

### FIELD OF THE INVENTION

The present invention relates to a system and method for locating products. More particularly, the present invention relates to a system and method for selecting a product having a desired characteristic. Even more particularly, the present invention relates to an icon selector and a corresponding icon, where the icon selector reflects product characteristics.

### BACKGROUND OF THE INVENTION

Identifying a product that has suitable characteristics that are appropriate for its intended use, and selecting such a product from amongst numerous other, similar products can be a daunting task for a consumer. For example, if a consumer desires to use an adhesive product, the consumer will need to consider the materials to be bonded, the environmental conditions the bond will experience, the condition of the bond site, and so forth. Failure to take such considerations into account could result in selecting an adhesive that is unsuitable for the consumer's task. Thus, the consumer, who may or may not be familiar with adhesives, will need to select an adhesive having bonding and other characteristics that are appropriate for the adhesive's intended use. To complicate matters, the consumer will have to select this adhesive from amongst many adhesive products that may differ from the appropriate adhesive in ways that are not obvious to the typical consumer. Therefore, a typical consumer will either make a best guess as to the appropriate adhesive or will attempt to determine the appropriate adhesive based on limited information presented in a store, on a web site, or the like.

A conventional method of making such a determination therefore involves a consumer reading product labels, marketing literature, etc., to discern the appropriate uses for a particular product so as to compare such uses to the consumer's task. In some cases, the labels do not address the application considerations that are important to the consumer. In other cases, the products are labeled in such a manner as to be confusing to the consumer, or to require extensive, time-consuming reading of packaging and/or literature before proper uses may be determined. This process may have to be repeated many times, across many different products. To complicate matters further, various brands of products may use different labeling conventions that necessitate a lengthy analysis on the part of the consumer to determine where the relevant information is located on the label.

Accordingly, what is needed is a system for enabling a consumer to make an educated product selection in an easy-to-use manner. More specifically, what is needed is a method for providing present characteristic choices to a consumer and enabling the choice selections to modify the appearance of an icon selector. Even more particularly, what is needed is a product selection system that enables a consumer to use an icon selector that is modified or created in accordance with desired product characteristics to match an icon displayed proximate a product having such desired characteristics.

### SUMMARY OF THE INVENTION

In light of the above shortcomings and drawbacks, a method and system for enabling a consumer to select a product having a desired characteristic is disclosed herein. In the method, a product selection guide is presented. The product selection guide has a choice corresponding to the desired characteristic, and an icon selector corresponding to a plurality of product characteristics. Modification of the icon selector, where the modification reflects a consumer choice selection, is enabled. Such a modification may be performed manually, electronically, mentally, or otherwise. In addition, an icon that has a visual appearance that is substantially similar to the modified icon selector may be displayed proximate the product. In some embodiments, the product selection guide has a question—that may be related to an intended use of the product—to elicit the choice selection from the consumer.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary embodiments of the invention; however, the invention is not limited to the specific methods and instrumentalities disclosed. In the drawings:

FIG. 1A is a diagram illustrating an exemplary guide according to one embodiment of the present invention;

FIGS. 1B-C are diagrams illustrating an exemplary electronic guide according to one embodiment of the present invention;

FIG. 2 is a diagram illustrating an exemplary product icon according to one embodiment of the present invention;

FIG. 3 is a flow chart illustrating a method of enabling a consumer to select a product having desired characteristics according to one embodiment of the present invention; and

FIG. 4 is a flow chart illustrating a computer-implemented method of enabling a consumer to select a product having desired characteristics according to one embodiment of the present invention.

### DETAILED DESCRIPTION OF ILLUSTRATIVE EMBODIMENTS

The subject matter of the present invention is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described. In addition, the word “consumer” is used herein to refer to anyone or entity that is seeking to select a product having certain characteristics. Therefore, “consumer” may refer to a private individual, a person acting in some official capacity (business, government, and so forth), an entity such as a business, or the like.

Overview

As will be discussed below, an embodiment of the present invention provides a guide, such as a questionnaire or the like, to enable a consumer to select desired characteristics of a product. For example, a product such as an adhesive may have characteristics of being able to bond different materials together, being waterproof, having a certain color, or the like. It will be appreciated, however, that any product may be selected in accordance with an embodiment of the present invention and that an embodiment is in no way limited to adhesive products, which are used herein merely for discussion purposes. Other products that may be used in connection with an embodiment include, but are not limited to: ink, paint, caulk, etc.

The guide, according to an embodiment of the present invention, may be implemented in any manner. For example, the guide may be in a static format such as a paper questionnaire or the like, or may be presented in a dynamic format, such as a web page, another type of electronic interface, etc. The guide may be configured so as to enable modifications to an icon selector according to the desired characteristics of the product. The modified icon selector may be substantially similar in its visual appearance to a corresponding icon that may be displayed proximate a product having the desired characteristics. Alternatively, a consumer may make a mental note of the appropriate modifications to the icon selector and then view icons with the modified icon selector in mind. The icon associated with the product may be located, for example, on a product label, on the product itself, on materials associated with the product, on a product display, or the like. In such a manner, an embodiment of the present invention enables a consumer to readily and accurately identify a product that possesses characteristics desired by the consumer.

Exemplary Embodiments

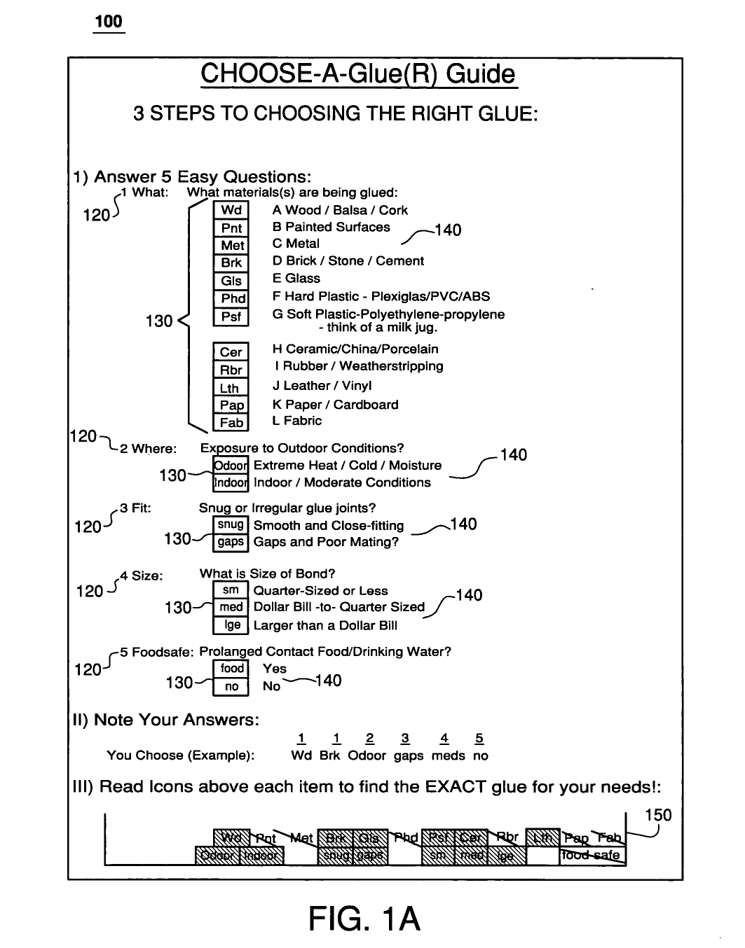

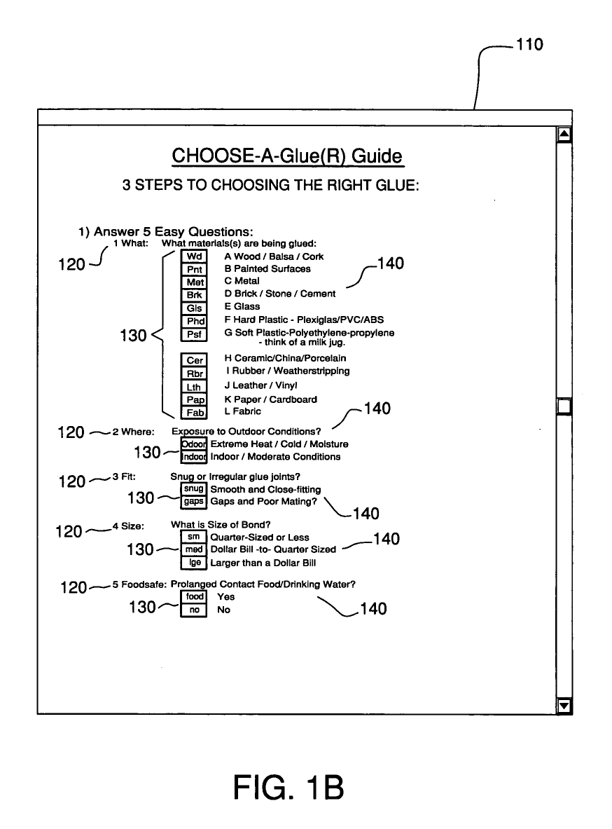

An embodiment of the present invention will now be described in connection with the appended drawings. Turning now to FIG. 1A, an exemplary guide in accordance with one embodiment of the present invention is illustrated. As can be seen in FIG. 1A, the guide 100 contains prompts 120, choices 130 and an icon selector 150 having images representing product characteristics 140. The prompts 120 in FIG. 1A are represented as statements or questions regarding the intended use of the product (e.g., “What material(s) are being glued?”). While such questions may be useful in eliciting information from a consumer regarding the product's intended use, it will be appreciated that any other type of statements and/or interrogatories may also be used in connection with an embodiment of the present invention. For example, true/false statements, multiple-choice questions and answers, and the like may be used in connection with an embodiment to elicit the desired product characteristics from a consumer.

The choices 130 are selectable by the consumer to indicate the desired characteristics of the product. In the exemplary guide 100 of FIG. 1A, for example, choices 130 represent answers to the prompts 120 discussed above. The choices 130 also represent the desired characteristics 140 of the product, as such characteristics pertain to their respective prompt 120. For example, in FIG. 1A, an adhesive characteristic 140 desired by a consumer may be the ability to form a bond between wood and brick. Therefore, an answer to the question “what material(s) are being glued?” would be “wood” and “brick.” Thus, choices 130 for wood and brick would be selected by a consumer to indicate this desired characteristic. It will be appreciated that the available choices 130 in FIG. 1A are words and/or abbreviations, any type of choice 130 may be made available by the guide 100. For example, images, text and the like may be used alone or in combination to form a choice 130 that is selectable by a consumer. In addition, the characteristics 140 need not be displayed as is shown in FIG. 1A, as the content of the choices 130 may convey the relevant characteristic 140 without rendering it necessary to list the characteristic 140 separately. Furthermore, the choice 130 may also provide adequate information to the consumer such that the prompts 120 are unnecessary.

The consumer may select various choices 130 by using any type of selection method. For example, the consumer may use a writing instrument or the like to annotate a selected choice 130 on the guide 100 to serve as a reminder for the consumer. Alternatively, the consumer may simply use the choices 130 as a mental guide, without making any annotations on the guide 100.

The icon selector 150 is provided by the guide 100 to enable a consumer to modify the appearance of the icon selector 150 in accordance with the consumer's selected choices 130 if the consumer so desires. Thus, and because the choices 130 reflect the consumer's desired product characteristics 140 as discussed above, the appearance of the modified icon selector 150 therefore also reflects the product characteristics 140 desired by the consumer. It will be appreciated that the icon selector 150 may be any type of visual aid, and that the icon selector 150 may use any means for representing desired product characteristics 140 such as, for example, text, images, symbols and the like. It will also be appreciated that the modified icon selector 150 may have a distinctive appearance formed the selected choices 130 and/or the non-selection of choices 130. For example, in FIG. 1A, the undesired choices 130 that form part of the icon selector 150 are crossed out, and the remaining, desired choices 130 form a block pattern (indicated by the shading) that is specific to the desired characteristics 140 of a product. Any manner of modification of the icon selector 150 based on selected and/or unselected choices 130 is equally consistent with an embodiment of the present invention.

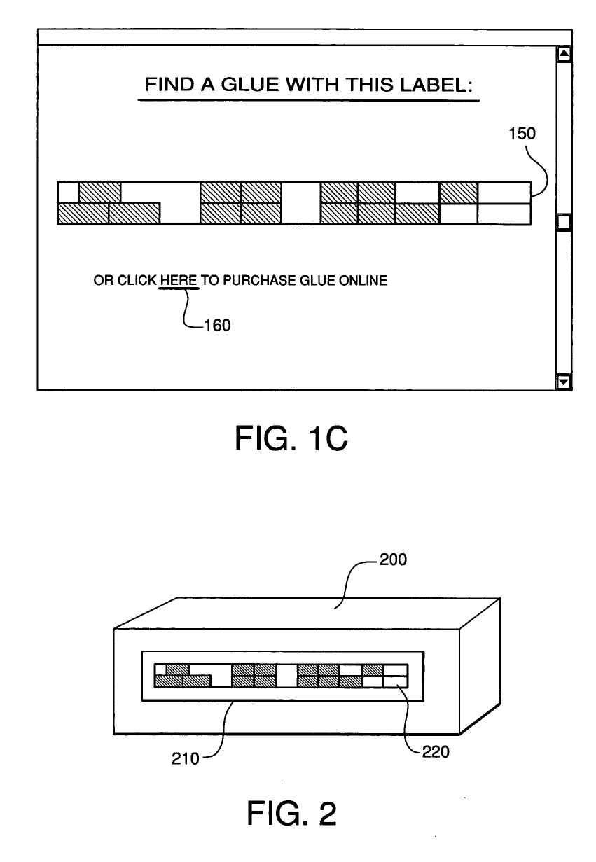

As was the case with the choices 130 discussed above, it will be appreciated that the consumer may modify the icon selector 140 using any type of selection method. For example, the consumer may use a writing instrument or the like to annotate a modification to the icon selector 140 to serve as a reminder for the consumer, or the consumer may simply modify the icon selector 140 mentally, without making any visible annotations on the icon selector 140. Thus, and as will be discussed below in connection with FIG. 2, a consumer who follows the guide 100 will have a modified icon selector 150 that may have a visual appearance that is substantially similar to an icon displayed proximate a product having the characteristics 140 desired by the consumer.

It is possible, in some situations, that a product having the consumer's desired characteristics may not be available. For example, the consumer may desire a product that is either out-of-stock or does not exist. In such a situation, the consumer may use the modified icon selector 150 to make an intelligent tradeoff to determine a suitable—although not perfectly matching—product. For example, the consumer may make an additional modification to the modified icon selector 150 to de-select a characteristic, and then use the twice-modified icon selector 150 to find an appropriate product. Thus, it will be appreciated that the icon selector 140 and modified icon selector 150 enable a consumer to make an informed product selection even when a perfectly-matching product is not available.

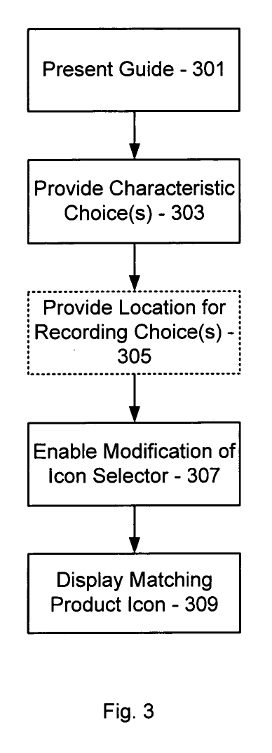

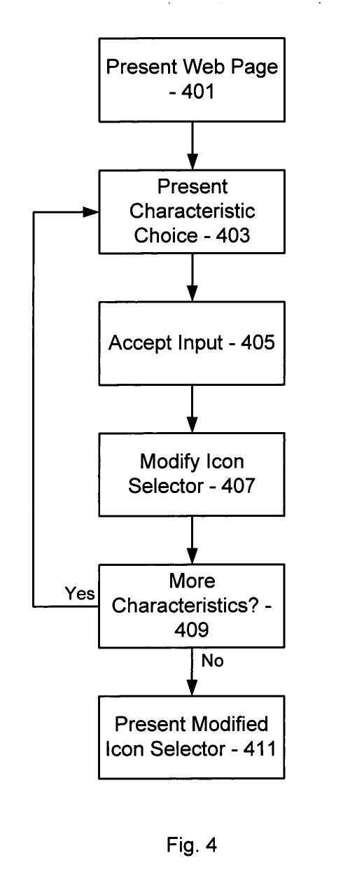

Referring now to FIG. 1B, an exemplary electronic guide 110 in accordance with an embodiment of the present invention is illustrated. As can be seen in FIG. 1B, the electronic guide 110 displays prompts 120 and choices 130 that reflect product characteristics 140 that may be desired by a consumer. The prompts 120, choices 130 and characteristics are as described above in connection with FIG. 1A; however, because of the electronic nature of the electronic guide, the display of the prompts 120, choices 130 and characteristics 140 may be static or dynamic. In embodiments where the electronic guide 110 is static, it may be used in a manner described below in connection with FIG. 3. In embodiments where the electronic guide is dynamically presented, it may used in a manner described below in connection with FIG. 4. In addition, it will be appreciated that the electronic guide 110 may be any type of electronically displayed image such as, for example, a web page, a display on a kiosk, or the like. The electronic guide 110—either completed or not—may be printed, emailed, or the like. As was the case with FIG. 1A above, the the choice 130 may also provide adequate information to the consumer such that the prompts 120 are unnecessary.

Turning now to FIG. 1C, a second view of an exemplary electronic guide 110 in accordance with an embodiment of the present invention is illustrated. In FIG. 1C, a completed icon selector 150 corresponding to the electronic guide 110 is shown. It will be appreciated that the icon selector 150 may be displayed at the same time as the prompts 120, choices 130 and/or characteristics 140 as discussed above in connection with FIG. 1B, or the icon selector may be dynamically generated as consumer selections are made, when all consumer selections are complete, or the like. Thus, the icon selector 150 of FIG. 1C is shown as a completed, or modified, icon selector 150 that represents the consumer's desired characteristics 140 for the product, although other electronic configurations of the icon selector 150 are possible. For example, an optional hyperlink 160 may be provided in connection with or in place of the icon selector 150. It will be appreciated that a consumer “click” on the hyperlink 160 may direct the consumer to a web site or the like where, for example, the consumer may be able to purchase the product, obtain additional information relating to the product, etc.

Referring now to FIG. 2, an exemplary product icon 220 displayed in accordance with one embodiment is illustrated. In FIG. 2, a label 210 containing an icon 220 is shown as being affixed to product packaging 200. It can be seen in FIG. 2 that the icon 220 displayed on the label 210 is an image that substantially matches the modified icon selector 150 discussed above in connection with FIGS. 1A and 1C (and not shown in FIG. 2 for clarity). For example, the icon 220 may comprise the same block pattern formed by the modified icon selector discussed above in connection with FIG. 1A. Thus, the icon 220 also represents the desired characteristics of the product contained within the packaging 200, enabling a consumer to simply match the icon 220 with the modified icon selector 150 to ensure that the product has the consumer's desired characteristics.

It will be appreciated that the icon 220 does not need to be part of a label 210, as it may be displayed directly on the product, and does not even need to be displayed on the product packaging 200 as is shown in FIG. 2. In some embodiments, the icon 220 may be located anywhere proximate the product 200. For example, the icon 220 may be located on a product stand or display, in a catalog of products 200, on a product-related web site or the like. In an embodiment where the icon 220 is displayed on a web site, it will be appreciated that the web site may be configured in accordance with the electronic guide discussed above in connection with FIGS. 1B-C, where the completed icon selector 140 may manually or automatically be used to identify a product having the appropriate characteristics as represented by the icon 220.

Thus, it will be appreciated that the guide (or electronic guide), the icon selector and the icon together form a system that enables a consumer to accurately and easily identify a product having certain desired characteristics. As noted above, the system may be implemented electronically—in the form of a web site, kiosk screen or the like—or may be implemented in any other manner such as, for example, as a paper guide and an icon displayed on a product package or on the product itself.

The discussion of FIGS. 3 and 4 to follow describes exemplary methods for enabling a consumer to identify and select a product. Turning now to FIG. 3, therefore, a flow chart illustrating a method of enabling a consumer to select a product having desired characteristics according to one embodiment of the present invention is illustrated. At step 301, a guide is presented. It will be appreciated that the guide that is presented at step 301 may be, for example, the guide 100 discussed above in connection with FIG. 1A. At step 303, one or more characteristic choices are provided. A characteristic choice may be in the form of a question, statement or the like. For example, the characteristic choice may be provided as described above in connection with the prompts 120, choices 130 and characteristics 140 as described above in connection with FIG. 1A, or may simply be one or more choices 130. Thus, at step 303, a consumer is able to identify one or more desired characteristics of the product in question.

At optional step 305, a location is provided that enables a consumer to record a choice made in connection with step 303. For example, the consumer's selection of a desired product characteristic may be recorded by the choice 130 discussed above in connection with FIG. 1A. Step 305 is optional because, as was noted above in connection with FIG. 1A, the consumer need not record the consumer's choice on the guide. Thus, the consumer may, in effect, make a mental record of the choice.

At step 307, the modification of an icon selector is enabled. The appearance of an icon selector, such as the icon selector 120 described above in connection with FIGS. 1A and 1C, is able to be modified by the consumer to reflect the consumer's choices regarding desired product characteristics. The modifications may be implemented by annotating desired characteristics, by annotating undesired characteristics, or any combination thereof. It will be appreciated that in an embodiment optional step 305 and step 307 may be combined into a single step, where the consumer is able to record the choice made in connection with step 303 by modifying the icon selector directly in step 307, without recording the choice beforehand as in step 305. In an embodiment, therefore, by enabling the modification of an icon selector the method of FIG. 3 enables a consumer to see a modified icon selector that corresponds to an icon displayed proximate a product (to be discussed below) that has the characteristics desired by the consumer. In another embodiment, and as discussed above, any modifications made to an icon selector may be made mentally by a consumer, rather than recorded on the icon selector. In such an embodiment, the consumer would look for an icon that is substantially similar to the modified icon selector about which the consumer is thinking.

At step 309, a product icon is displayed proximate a product having the characteristics desired by the consumer. As was discussed above in connection with FIG. 2, the product icon is substantially similar to the modified icon selector. Thus, in some embodiments the modified icon selector and the product icon share some visual styling, appearance, characteristics or the like to enable a consumer to determine that the product icon matches the modified icon selector. As was also discussed above in connection with FIG. 2, in one embodiment the icon may be displayed on a label affixed to product packaging. In addition, the icon may be displayed on the product itself, on a product stand near the product, or in any other location that provides some correlation to the product having the desired characteristics. Furthermore, any or all of such display methods may be used in any combination.

Thus, an embodiment of the present invention enables a consumer to find a product having desired characteristics by simply matching two visual symbols—the modified icon selector and the product icon—rather than having to directly identify the characteristics of the product. It will be appreciated that the modified icon selector and the product icon therefore act as an intermediary to remove the burden of reading numerous product labels, etc., from the consumer. Instead, the consumer is able to review a single guide, make choices based on desired product characteristics, modify an icon selector based on such choices, and then match the modified icon selector to a product icon. In effect, the more difficult process of determining an appropriate product that has desired characteristics is performed up-front, in the process of making choices and modifying the icon selector. In such a manner, the process only needs to be performed once per product. Then, the consumer is able to simply match the modified icon selector to a product icon, which can be as simple as matching two visual symbols. Thus, for example, if a consumer is looking for a product in a store while using a modified icon selector in accordance with an embodiment of the present invention, the consumer need only match the visual symbols (modified icon selector to product icon), rather than having to read details of numerous product labels. As was discussed above in connection with FIG. 1A, the consumer may also use a modified icon selector to find a product icon that matches only a portion of the modified icon selector in situations where a perfectly-matching product is not available, for example.

Referring now to FIG. 4, a flow chart illustrating a computer-implemented method of enabling a consumer to select a product having desired characteristics according to one embodiment of the present invention is provided. It will be appreciated that the steps 401-407 to be discussed below closely parallel steps 301-307 discussed above in connection with FIG. 3, except that the steps of FIG. 4 take place in an electronic environment.

At step 401, therefore, an electronic guide is presented. It will be appreciated that the electronic guide that is presented at step 401 may be the electronic guide 110 discussed above in connection with FIG. 1B. At step 403, one or more characteristic choices are presented. As was the case with step 303 discussed above in connection with FIG. 3, a characteristic choice may be in the form of a question, statement or the like. Furthermore, the choices may be presented in any possible electronic manner. Thus, images, sounds, animation and the like may be used in any combination to present such choices to a consumer. For example, in one embodiment, the choices may be presented in connection with audio cues to help the consumer understand the choice that is to be made regarding one or more desired product characteristics.

At step 405, a consumer's input regarding the choice selected in connection with the choice(s) presented above in step 403 is accepted. For example, if the electronic guide is presented as a web page, the selections may be made by “clicking,” or the like, on a choice denoting a characteristic desired by the consumer. It will be readily appreciated that the input may be accepted in any manner including, but not limited to, audio inputs (e.g., voice recognition), mouse inputs, keyboard inputs, and the like.

At step 407, the an icon selector is modified to reflect the input accepted above in connection with step 405, which in turn represents the desired characteristic identified by the consumer's characteristic choice. It will be appreciated that while step 407 is shown in FIG. 4 as taking place for every characteristic choice, step 407 may take place at one time after all choices are made (i.e., after step 409, to be discussed below). In one embodiment, therefore, by enabling the modification of the icon selector after every consumer choice, the method of FIG. 4 enables a consumer to see each modification to the icon selector that is made in response to each choice. Likewise, in another embodiment, by enabling the modification of the icon selector after all consumer choices have been made, the consumer is presented only with a completed, modified icon selector. It will be appreciated that any combination of the above approaches may be used, whereby the icon selector is modified at predetermined intervals or the like. In any event, the completed, modified icon selector corresponds to an icon displayed proximate a product (to be discussed below) that has the characteristics desired by the consumer.

At step 409, a determination is made as to whether additional product characteristics need to be selected. If so, the method returns to step 403 for the next product characteristic. If not, the method proceeds to step 411. For example, in one embodiment, the characteristic choices may be presented dynamically, where characteristic choices are determined by previous choices. For example, a first characteristic choice may prompt the consumer to select a type of product from amongst a variety of product types. Thus, if the consumer selects, for example, an adhesive product, a following characteristic choice may concern the types of materials to be bonded by the adhesive. In such an embodiment, a consumer's characteristic choice may necessitate additional choices, or may end the presentation of choices. Thus, in such an embodiment, a single electronic guide may be presented to enable a consumer to select any number of different products having any number of desired characteristics.

At step 411, a modified icon selector is presented. It will be appreciated that the modified icon selector may be presented on an electronic display, printed, transmitted electronically, and/or the like. As noted above, the icon selector may be presented to a consumer throughout each step of the method of FIG. 4, or the icon selector may be presented only once it is modified to reflect every desired characteristic. Thus, a consumer, at the completion of step 411, is in possession of a modified icon selector as was the case at the completion of step 307 of FIG. 3.

As was also discussed above in connection with FIGS. 2 and 3, a product icon corresponds to the modified icon selector. Thus, a consumer may use the modified icon selector generated during the method of FIG. 4 to identify a product having desired characteristics by way of the product icon. For example, in an embodiment where the modified icon selector is printed, a consumer may use the printed, modified icon selector to identify a product having the desired characteristic(s). In another embodiment, the consumer may use a web site—possibly the web site having the electronic guide—to order the product, and may use the modified icon selector as a check to determine whether the ultimately-delivered product is correct. In yet another embodiment, if the electronic guide is displayed by an in-store kiosk, the modified icon selector may be displayed in connection with instructions as to the location of the product. A product icon matching the modified icon selector may also be displayed proximate the product so as to enable the consumer to verify a product as having the desired characteristics. It will therefore be appreciated that any number of configurations are enabled by an embodiment of the present invention.

Thus, a method and system for enabling a consumer to select a product having desired characteristics has been provided. While the present invention has been described in connection with the exemplary embodiments of the various figures, it is to be understood that other similar embodiments may be used or modifications and additions may be made to the described embodiment for performing the same function of the present invention without deviating therefrom. Therefore, the present invention should not be limited to any single embodiment, but rather should be construed in breadth and scope in accordance with the appended claims.

1. A method of enabling a consumer to select a product having a desired characteristic, comprising:
presenting a product selection guide having a choice corresponding to the desired characteristic and an icon selector corresponding to a plurality of product characteristics,
enabling the modification of the icon selector to reflect a consumer selection of the choice; and
displaying an icon that is substantially similar to the modified icon selector proximate the product.

2. The method of claim 1, wherein the product selection guide further has a prompt to elicit the selection of the choice from the consumer.

3. The method of claim 2, wherein the prompt is a question relating to an intended use of the product.

4. The method of claim 1, wherein the icon selector symbolically represents the plurality of product characteristics.

5. The method of claim 1, wherein the icon is affixed to the product.

6. The method of claim 1, wherein the icon is affixed to packaging containing the product.

7. The method of claim 1, wherein the icon is displayed on a product display.

8. The method of claim 1, wherein the icon is displayed in a retail establishment.

9. The method of claim 1, wherein the product is an adhesive.

10. A method of assisting a consumer to select a product having a desired characteristic, comprising:
electronically presenting a guide having a choice corresponding to the desired characteristic;
accepting a selection of the choice from the consumer;
modifying an icon selector according to the selection, wherein the icon selector represents a plurality of product characteristics; and
presenting the modified icon selector to the consumer.

11. The method of claim 10, further comprising presenting an icon having an appearance substantially similar to the modified icon selector.

12. The method of claim 11, wherein the icon is a first icon, and further comprising presenting a second icon proximate the product.

13. The method of claim 12, wherein the second icon is presented on a product display.

14. The method of claim 10, wherein the icon is presented electronically.

15. The method of claim 14, wherein the icon is presented on a web site.

16. The method of claim 14, wherein the icon is presented by a kiosk.

17. The method of claim 14, wherein a hyperlink is presented with the icon.

18. The method of claim 10, wherein the product is an adhesive.

19. A computer-readable medium having computer-executable instructions for performing a method of assisting a consumer to select a product having a desired characteristic, the method comprising:
electronically presenting a guide having a choice corresponding to the desired characteristic;
accepting a selection of the choice from the consumer;
modifying an icon selector according to the selection, wherein the icon selector represents a plurality of product characteristics; and
presenting the modified icon selector to the consumer.

20. A product selection system, comprising:
a product selection guide, wherein the product selection guide has a choice corresponding to a desired product characteristic, and an icon selector corresponding to a plurality of product characteristics, wherein the icon selector is modifiable in response to a consumer selection of the choice; and
an icon displayed proximate a product having the desired characteristic, wherein the icon substantially matches the appearance of the modified icon selector.

21. The product selection system of claim 20, wherein the product selection guide further has a prompt to elicit the consumer choice selection.

22. The product selection system of claim 21, wherein the prompt is a question relating to an intended use of the product.

23. The product selection system of claim 20, wherein the icon selector visually represents the plurality of product characteristics.

24. The product selection system of claim 20, wherein the icon is displayed on the product.

25. The product selection system of claim 20, wherein the icon is displayed on product packaging.

26. The product selection system of claim 20, wherein the product is located in a retail establishment.

27. The product selection system of claim 20, wherein the product is an adhesive.

28. The product selection system of claim 27, wherein the characteristic is a material suitable for use with the adhesive.

29. A product selection guide, comprising:
a choice corresponding to a desired characteristic of a product; and
an icon selector corresponding to a plurality of product characteristics, wherein the icon selector is modifiable in response to a consumer selection of the choice, and wherein the modified icon selector substantially matches the appearance of an icon displayed proximate a product having the desired characteristic.

30. The product selection guide of claim 29, wherein the product selection guide further comprises a prompt to elicit the consumer selection of the choice.

31. The product selection guide of claim 30, wherein the prompt is a question relating to an intended use of the product.

32. The product selection guide of claim 29, wherein the icon selector provides a means for the consumer to annotate the choice selection.

33. The product selection guide of claim 29, further comprising a location for the consumer to annotate the choice selection.

34. The product selection guide of claim 29, wherein the icon selector visually represents the plurality of product characteristics.

35. The product selection guide of claim 29, wherein the icon is displayed on the product.

36. The product selection guide of claim 29, wherein the icon is displayed on product packaging.

37. The product selection guide of claim 29, wherein the product is located in a retail establishment.

38. The product selection guide of claim 29, wherein the product is an adhesive.

39. The product selection guide of claim 38, wherein the characteristic corresponds to a material suitable for bonding with the adhesive.
